(19) United States
(12) Patent Application Publication
(10) Pub. No.: US 2007/0243042 A1
(43) Pub. Date: Oct. 18, 2007

(54) Slotless locking pull pin

(76) Inventor: Romy J. Baus, Rubicon, WI (US)

Correspondence Address: RYAN KROMHOLZ & MANION, S.C., POST OFFICE BOX 26618, MILWAUKEE, WI, 53226, US

(21) Appl. No.: 11/710,083

(22) Filed: Feb. 23, 2007

Related U.S. Application Data
(60) Provisional application No. 60/777,281, filed on Feb. 27, 2006.

(51) Int. Cl. F16B 21/00

(52) U.S. Cl. 411/347

(57) ABSTRACT

A slotless locking pull pin having a handle, a pin, a housing, an internal spring and a locking mechanism. The pull pin has an internal spring which biases the pin in its normal extended position. The pull pin has a locking mechanism which locks the pin in its retracted position. The locking mechanism may include locking structure located on the pin and a locking plate located in the housing. The locking structure engages the locking plate and holds the pin in its retracted position.

### RELATED APPLICATIONS

This application claims the benefit of co-pending U.S. Provisional Patent Application Ser. No. 60/777,281, filed 27 Feb. 2006.

### BACKGROUND OF THE INVENTION

Pull pins are a commonly used method of adjustably attaching two pieces of material. Pull pins are generally used in situations where two pieces slide close to each other and quick adjustment is desired. For example, on the legs of a table or a tripod. The pull pin is threaded into a hole in the first piece and the pin extends through a hole in the second piece. Commonly, the second piece is provided with a number of holes, and a handle of the pin is pulled to retract the pin and allow for adjustments. Pull pins are generally spring loaded such that when the handle is released, the pin returns to its normal extended position.

Locking pull pins are also common. Locking pull pins are pulls pins which are configured such that they can be locked in the retracted position. Locking pull pins which are currently on the market have a slot located at the end of the pin near the handle. This slot is adapted such that the handle can slide in the slot. When the pin is in its extended position, the handle is slid at least partially into the slot. To lock the pin in the retracted position, the pin is pulled back to the retracted position and the pin is rotated such that the handle rests on the end of the housing. While this type of locking pull pin is commonly used, there are problems associated with it. Most importantly, a slot has to be machined on each pull pin. This machining adds to the labor time associated with making a locking pull pin and therefore increase the cost of such a part. It is desirable to design a pull pin which does not require a slot to be machined on the housing of the pull pin.

### SUMMARY OF THE INVENTION

The present invention provides a slotless locking pull pin. The pull pin includes a handle, a pin, a housing, an internal spring, and a locking mechanism.

In one embodiment the locking mechanism includes a plunger on the pin and a locking plate in the housing. In this embodiment the plunger may be engaged by either a tool or by hand.

In a second embodiment the locking mechanism includes a protrusion on the pin and a keyhole shaped aperture in the locking plate. In this embodiment the pin is held in locking position by pulling the protrusion through the keyhole and rotating the pin so the protrusion engages the locking plate. To release the pin, the pin is rotated to align the protrusion with the keyhole and the pin is returned and to its extended position.

In a third embodiment the locking mechanism includes a plunger disposed in the pin and a keyhole shaped aperture in the locking plate. In this embodiment the pin is held in locking position by pulling the pin into the retracted position such that the plunger engages the locking plate. The plunger may have a ramped surface which engages the interior of the aperture in the locking plate to depress the plunger. To release the pin, the pin is rotated to align the plunger with the keyhole and the pin is returned to its extended position.

In a fourth embodiment the locking mechanism includes a plunger disposed in the pin, a collar, and a locking plate. In this embodiment the pin is held in locking position by pulling the pin into the retracted position such that the plunger engages the locking plate. The plunger has a ramped surface which engages the interior of the aperture in the locking plate to depress the plunger. To release the pin, the collar is pushed toward the housing. The surface of the collar engages the ramped surface on the plunger and depresses the plunger so the pin can be returned to its extended position.

In a fifth embodiment, the locking mechanism includes a plunger disposed in the pin, a collar, and a locking plate. In this embodiment the plunger does not have a ramped surface, but both the collar and the locking plate have ramped surfaces. In this embodiment the pin is held in locking position by pulling the pin into the retracted position such that the plunger engages the locking plate. The ramped surface of the locking plate engages the plunger and depresses the plunger. To release the pin, the collar is pushed toward the housing. The ramped surface of the collar engages the surface on plunger and depresses the plunger so the pin can be returned to its extended position.

### BRIEF DESCRIPTION OF THE DRAWINGS

FIG. 1A is a partially cut away perspective view of a preferred embodiment of the present invention in the retracted position.

FIG. 1B is a perspective view of a preferred embodiment of the present invention in the extended position.

FIG. 2 is a perspective view of an alternate embodiment of a locking mechanism according to the present invention.

FIG. 3 is a perspective view of a second alternate embodiment of a locking mechanism according to the present invention.

FIG. 4 is a perspective view of a third alternate embodiment of a locking mechanism according to the present invention.

FIG. 5A is a perspective view of the locking mechanism of FIGS. 1A and 1B.

FIG. 5B is a sectional view of the locking mechanism of FIG. 5A.

FIG. 6A is a perspective view of an alternate embodiment of a locking mechanism according to the present invention.

FIG. 6B is a sectional view of the locking mechanism of FIG. 6A.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

A preferred embodiment of the invention is shown in photographs attached in the appendix.

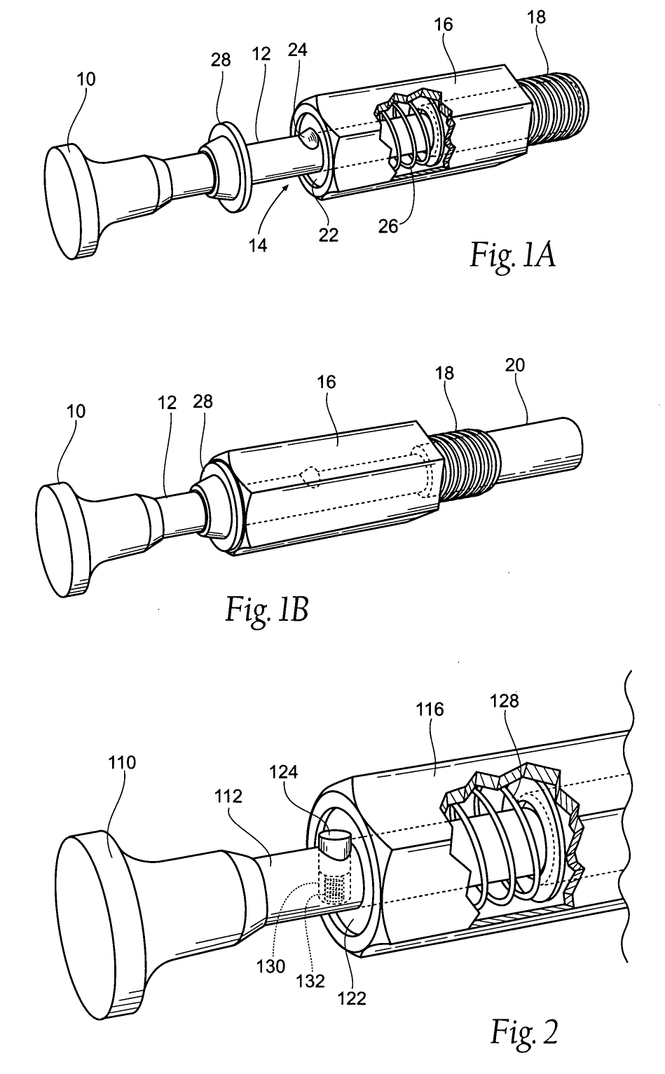

FIGS. 1A and 1B show a preferred embodiment of the slotless locking pull pin of the present invention. The pull pin includes a handle 10, a pin 12, a locking mechanism 22, 24, and a housing 16. The housing 16 has a threaded portion 18 on at least one end portion thereof. The housing 16 further includes a bore extending through the housing 16. The pin 12 is disposed within the bore in the housing 16. The pin 12 is generally cylindrical and has a first end 20 which is normally located outside the threaded portion 18 of the housing 16 and a second end. The handle 10 is attached to the second end of the pin 12. The handle 10 may be of any type commonly used in the art, including, but not limited to a pull ring or a pull bar.

The locking mechanism shown in FIGS. 1A and 1B includes a locking plate 22 located in the housing 16 and locking portion 24 on the pin 12. The locking plate 22 has an aperture through which the pin 12 extends. The pin 12 has a locking portion 24 which engages the locking plate 22 to hold the pin 12 in its retracted position. A spring 26 is also disposed within the housing 16 to bias the pin 12 to its normally extended position.

FIG. 2 shows a first embodiment of a locking mechanism. The locking mechanism includes a plunger 124 disposed in a bore 130 in the pin 112. The bore 130 extends partway through the pin 112. The plunger 124 is slidably disposed in the bore 130. Biasing means 132 are located below the plunger 124. The biasing means 132 in the preferred embodiment is a coil spring; however other biasing means could be utilized including, but not limited to a leaf spring, compressible material, or elastic material. The biasing means 132 push the plunger 124 to its outwardly extending position where the plunger 124 extends from the surface of the pin 112. The locking mechanism also includes a locking plate 122. The locking plate 122 includes a circular hole which is sized just large enough for the pin 112 to fit through.

In use, the operator either uses a tool to depress the plunger 124, or depresses the plunger 124 by hand. Once the plunger 124 clears the locking plate 122, the pin 112 will be returned to its normal extended position by the force of the spring 128 located within the housing 116.

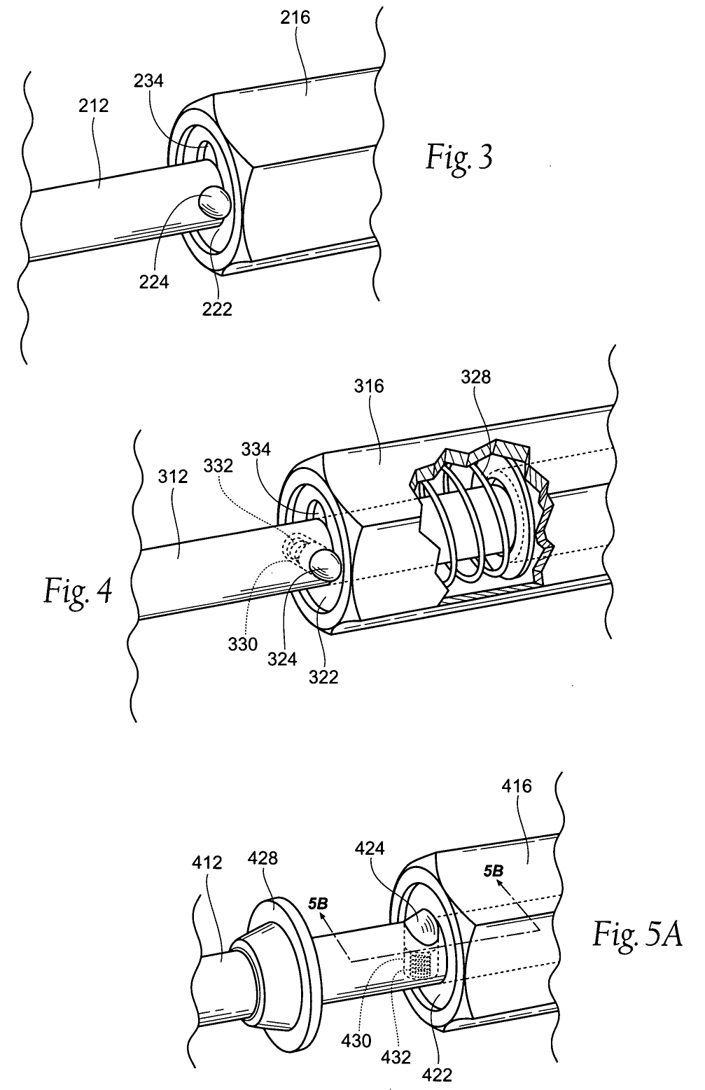

FIG. 3 shows a second embodiment of the locking mechanism. In this embodiment, the locking plate 222 includes a keyhole shaped aperture. The pin 212 is provided with a protrusion 224 on its surface. The aperture is sized such that when the protrusion 224 is lined up with the notch 234 of the aperture the pin 212 can be slid through the aperture. In use, the protrusion 224 on the pin 212 is aligned with the notch 234 of the aperture and the pin 212 is pulled to its retracted position. The pin 212 is then rotated so that the aperture engages the locking plate 222. The pin 212 can then be released and will stay in its locked position. To return the pin 212 to its extended position, the pin 212 is again rotated so that its protrusion 224 is aligned with the notch 234 of the aperture in the locking plate 222. The pin 212 can then be released and the spring 228 within the housing 216 will return the pin 212 to its normal extended position.

FIG. 4 shows a third embodiment of the locking mechanism. The embodiment of FIG. 4 is similar to the embodiment of FIG. 3; however, the embodiment shown in FIG. 4 includes a plunger 324 disposed in a bore 330 in the pin 312. The plunger 324 may have a ramped engaging surface which is used as a cam. The ramped engaging surface is proximate the surface of the pin on the side nearest the handle. The ramped engaging surface then extends upward, away from the surface of the pin 312. This configuration allows the locking plate 322 to engage the ramping surface and depress the plunger 324 into the bore 330. In this manner the pin 312 may be pulled to its retracted position without aligning the plunger 324 with the notch 334 of the aperture. The pin 312 may be retained in its retracted position by the plunger 324 engaging the locking plate 322. The pin 312 may be returned to its extended position by rotating the pin 312 so the plunger 324 is aligned with the notch 334 of the aperture in the locking plate 322. The pin 312 can then be released and the spring 328 within the housing 316 will return the pin 312 to its normal extended position.

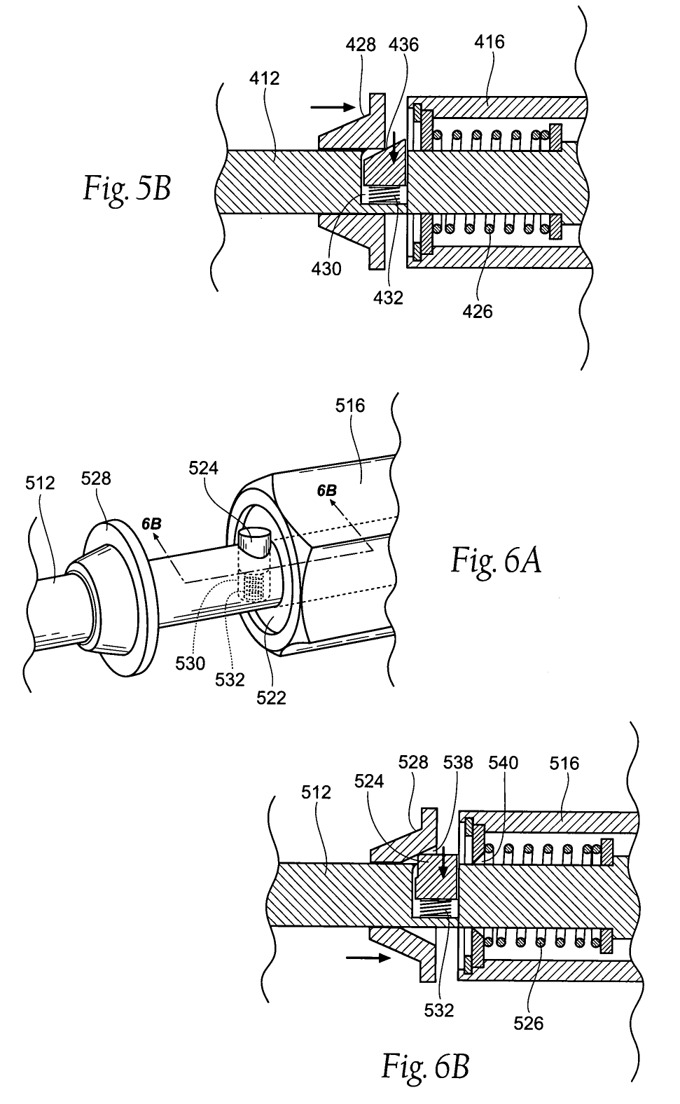

FIGS. 5A and 5B show a fourth embodiment of a locking mechanism. This embodiment is also shown in FIGS. 1A and 1B. This embodiment includes a plunger 424 disposed in a bore 430 in the pin 412. The plunger 424 has a ramped engaging surface 436 which is used as a cam. The ramped engaging surface 436 is proximate the surface of the pin 412 on the side nearest the handle. The ramped engaging surface 436 then extends upward, away from the surface of the pin 412. The locking plate 422 has a generally circular aperture which is sized such that the pin 412 fits through the aperture. This embodiment also includes a collar 428 which is slidably located on the pin 412 and is located between the handle and the housing 416.

In use, the pin 412 is pulled to its locked position. As the pin 412 is pulled, the ramped engaging surface 436 of the plunger 424 engages the inner surface of the aperture in the locking plate 422. The force of the locking plate 422 causes the plunger 424 to be pushed inwardly into the bore 430. Once the ramped engaging surface 436 clears the locking plate 422, the plunger 424 pops back to its normal outwardly biased position. The engagement of the plunger 424 with the locking plate 422 locks the pin 412 and prevents the pin 412 from returning to its extended position.

To return the pin 412 to its extended position, the collar 428 is pushed toward the housing 416. As the collar 428 engages the ramped engaging surface 436 of the plunger 424, the plunger 424 is pushed into the bore 430. Once the plunger 424 is pushed below the surface of the pin 412, the pin 412 will be returned to its normally extended position by the force of the spring 426 located in the housing 416. Although the spring is not shown in this embodiment, the configuration of the spring is the same as the previous embodiments. After the plunger 424 clears the locking plate 422 the plunger 424 will pop back to its normal outwardly biased position.

FIGS. 6A and 6B show a fifth embodiment of a locking mechanism. This embodiment includes a plunger 524 disposed in a bore 530 in the pin 512. The locking plate 522 has a generally circular aperture which is sized such that the pin 512 fits through the aperture. As shown in FIG. 6B, the aperture in the locking plate 522 is conically shaped and includes a conical aperture surface 540. This embodiment also includes a collar 528 which is slidably located on the pin 512 and is located between the handle and the housing 516. As is seen in FIG. 6B, the interior of the collar 528 has a conical shape similar to that of the locking plate 522, and includes a collar conical surface 538. The collar conical surface 538 and the conical aperture surfaces 540 act as cams.

In use, the pin 512 is pulled to its locked position. As the pin 512 is pulled, the conical aperture surface 540 engages the leading edge of the plunger 524. As the pin 512 is pulled, the plunger 524 is pushed into the bore 530. Once the plunger 524 clears the locking plate 522, the plunger 524 pops back to its normal outwardly biased position.

To return the plunger 524 to its extended position, the collar 528 is pushed toward the housing 516. As the collar conical surface 538 engages the plunger 524, the plunger 524 is pushed into the bore 530. Once the plunger 524 is pushed below the surface of the pin 512, the pin 512 will be returned to its normally extended position by the force of the spring 526 located in the housing 516. After the plunger 524 clears the locking plate 522 the plunger 524 will pop back to its normal outwardly biased position.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

I claim:

1. A locking pull pin comprising:
a housing, the housing having a first end and a second end and further having a bore extending therethrough from the first end to the second end;
a pin, the pin being slidably disposed in the housing and having a first end located proximate to the first end of the housing, the pin having a second end located proximate to the second end of the housing;
an internal spring disposed in the housing; and
a locking mechanism located at the first end of the housing, said locking mechanism including a first portion disposed on the housing and a second portion disposed on the pin.

2. The locking pull pin of claim 1 wherein said first portion of the locking mechanism further comprises a locking plate coupled to the first end of said housing, said locking plate having an aperture therethrough, wherein the pin extends through the aperture.

3. The locking pull pin of claim 2 wherein said second portion of the locking mechanism further comprises a plunger slidably disposed in a bore formed on said pin, the bore including a biasing member biasing the plunger outward, the plunger further including at least one surface adapted for locking engagement with the locking plate.

4. The locking pull pin of claim 3 wherein the biasing member is a coil spring.

5. The locking pull pin of claim 3 wherein the biasing member is a leaf spring.

6. The locking pull pin of claim 3 wherein the biasing member is an elastic material.

7. The locking pull pin of claim 3 wherein the biasing member is a compressible material.

8. The locking pull pin of claim 1 further comprising a handle coupled to the first end of the pin.

9. The locking pull pin of claim 1 further comprising a hollow threaded portion coupled to the second end of said housing.

10. The locking pull pin of claim 1 wherein the spring is a coil spring and the pin extends through the center of the coil spring.

11. The locking pull pin of claim 2 wherein said pin further includes a protrusion formed on a surface of said pin proximate the first end of the pin, and said pin is rotatably seated in the housing; and
said locking plate aperture including a second aperture, the second aperture being sized and configured such that when the pin protrusion is aligned with the second aperture the pin protrusion may be passed therethrough.

12. The locking pull pin of claim 3 further comprising means for depressing the plunger.

13. The locking pull pin of claim 12 wherein the means for depressing comprises a collar slidably coupled to said pin, said collar having an inner surface.

14. The locking pull pin of claim 13 wherein at least a portion of the plunger is angled to form a cam surface, said cam surface being adapted for engagement with the inner surface of the collar.

15. The locking pull pin of claim of claim 13 wherein the collar inner surface is angled to form a cam surface, said cam surface being adapted for engagement with an outer surface of the plunger.

16. The locking pull pin of claim of claim 15 wherein the locking plate aperture is conically shaped, the locking plate aperture having a surface adapted to act as a cam surface.

17. A locking pull pin comprising:
a housing, the housing having a first end and a second end and further having a bore extending therethrough from the first end to the second end;
a pin, the pin being slidably disposed in the housing and having a first end located proximate to the first end of the housing, the pin having a second end located proximate to the second end of the housing;
an internal spring disposed in the housing;
a locking plate coupled to the first end of said housing, said locking plate having an aperture therethrough, wherein the pin extends through the aperture;
a plunger slidably disposed in a bore formed on said pin, the bore including a biasing member biasing the plunger outward, the plunger further including at least one surface adapted for locking engagement with the locking plate; and
a collar slidably coupled to said pin, said collar having an inner surface for engaging said plunger.

18. A locking pull pin comprising:
a housing, the housing having a first end and a second end and further having a bore extending therethrough from the first end to the second end;
a pin, the pin being slidably disposed in the housing and having a first end located proximate to the first end of the housing, the pin having a second end located proximate to the second end of the housing;
an internal spring disposed in the housing; and
a locking mechanism, said locking mechanism including a protrusion formed on the pin and an aperture formed in the locking plate.

19. The locking pull pin of claim 18 further comprising a handle coupled to the first end of the pin.

20. The locking pull pin of claim 18 further comprising a hollow threaded portion coupled to the second end of said housing.
